(19) United States
(12) Patent Application Publication
(10) Pub. No.: US 2019/0291032 A1
(43) Pub. Date: Sep. 26, 2019

(54) REMOVABLE CONNECTOR FOR FILTER SYSTEM

(71) Applicant: Micahel T. Baird, Temecula, CA (US)

(72) Inventor: Micahel T. Baird, Temecula, CA (US)

(21) Appl. No.: 16/357,068

(22) Filed: Mar. 18, 2019

Related U.S. Application Data
(60) Provisional application No. 62/646,732, filed on Mar. 22, 2018.

(51) Int. Cl. B01D 35/153; B01D 35/30; C02F 1/00

(52) U.S. Cl. CPC B01D 35/153; B01D 35/30; C02F 2201/006; B01D 2201/302; C02F 1/003

(57) ABSTRACT

A head for a water filter cartridge has a cap with an open end configured to mate with a filter body. An axial tube extends along the cap's longitudinal axis. First and second lateral tubes extend laterally from the cap. The first lateral tube intersects the first axial tube and places those tubes in fluid communication. The second lateral tube intersects the cap to place the second lateral tube in fluid communication with an inside of the cap. The first and second lateral tubes have a sidewall opening to allow fluid communication with a manifold. A tubular fitting intersects at least one of the cap or first lateral tube and is on the longitudinal axis, aligned with the first axial tube. The fitting has a closed end which, when removed, allows flushing of the axial tube and an attached filter.

### CROSS-REFERENCE TO RELATED APPLICATIONS

The application claims the benefit under 35 U.S.C. § 119(e) to Provisional Patent Application No. 62/646,732 filed Mar. 22, 2018, the entire contents of which are incorporated herein by reference.

### STATEMENT RE: FEDERALLY SPONSORED RESEARCH/DEVELOPMENT

Not applicable.

### BACKGROUND

Water filtration systems typically have an unfiltered water inlet line connected to a water inlet port of a water filter cartridges, and a water outlet line connected to a water outlet port of the same, with the filter cartridges connected singly, serially or in parallel. The filter ports are typically cylindrical or oval nozzles using O-ring seals to prevent leakage during use. The water filter cartridges typically have an Ultra Filtration (UP′) filter or a Reverse Osmosis (“RO”) filter contained in a canister or cartridge with suitable ports for releasably connecting to the water system's manifold or to the water lines. The filter cartridges can be bulky as they can vary from 20 to 40 inches long and 6 to 12 inches in diameter, or larger. The filter cartridges can also be heavy, especially the larger filter cartridges for commercial use in restaurants and office buildings. Small filter cartridges may be inserted vertically into the bottom of a manifold connected to the water lines and held in place by a bayonet mount. But as the filter cartridge weight and diameter increase, it becomes very difficult to manually remove an exhausted filter cartridge and replace it with a new filter cartridge. There is thus a need for an improved and more convenient connection for removably connecting filter cartridges to manifolds and to water lines.

As the filter cartridge size and weight increase, the bayonet tabs and associated connecting structure becomes more massive to support the filter cartridge weight which is suspended from the manifold or water line. There is thus a need for an improved connection that better accommodates the weight of the water filter cartridges.

As the filter cartridges become larger in size, the manifold is located further away from the supporting wall to which the water lines are fastened, and the replacement of the filter cartridges requires a lateral space larger than diameter and large enough to also safely accommodate passage of the user's arms and hands. The result is that the filter cartridges are located in large cabinets or other roomy enclosures to allow sufficient room for access and to achieve the fluid connection with the manifold or water lines. There is thus a need for an improved connection that requires less lateral room to install and remove a filter cartridge from a manifold and/or water line.

### BRIEF SUMMARY

A head for a water filter cartridge has a cap with an open end configured to mate with a filter body. An axial tube extends along the cap's longitudinal axis. First and second lateral tubes extend laterally from the cap. The first lateral tube intersects the first axial tube and places those tubes in fluid communication. The second lateral tube intersects the cap to place the second lateral tube in fluid communication with an inside of the cap. The first and second lateral tubes have a sidewall opening to allow fluid communication with a manifold. A tubular fitting intersects at least one of the cap or first lateral tube and is on the longitudinal axis, aligned with the first axial tube. The fitting has a closed end which, when removed, allows flushing of the axial tube and an attached filter. The head may be releasably connected to a single end of a tubular filter cartridge, or a head may be releasably connected to opposing ends of a tubular filter.

There is advantageously provided a connector head for a water filter cartridge having a housing containing a filter material. The connector head includes a water filter cap having an open end and an opposed second end joined to the open by a wall. The water filter cap has a longitudinal axis encircled by the open end of the water filter cap. A first axial tube extends along the longitudinal axis and defines a first axial flow passage extending along a portion of the longitudinal axis of the water filter cap. A first lateral tube extends laterally outward and intersects the first axial tube. The first lateral tube defines a first lateral tube passage in fluid communication with the first axial flow passage. The connector head has a second lateral tube extending laterally outward and intersecting at least one of the wall of the water filter cap and the second end of the cap. The second lateral tube defines a second lateral tube passage in fluid communication with an inside of the water filter cap. The first and second lateral tubes each have an opening in a sidewall of the lateral tubes at or adjacent to a proximal end of the respective tubes. A tubular fitting intersects at least one of the water filter cap or first lateral tube and extends along the longitudinal axis.

In further variations, the connector head may include an outwardly extending flange encircling the open end of the water filter cap, where the flange has at least one of two opposing sides inclined toward the other side in a direction away from the longitudinal axis. The connector head may also include a sealing ring located between the flange and the open end of the water filter cap.

Additionally, the connector head may have the proximal end of at least one of the first and second lateral tubes be closed and further have at least one cylindrical recess in that closed tube extending along a recess axis which is offset from a longitudinal axis of the at least one of the first and second lateral tubes having the at least one cylindrical recess. Further, the first lateral tube may extend along a first lateral axis and have a generally cylindrical portion at a proximal end of the first lateral tube, and the generally cylindrical portion may further have an offset longitudinal axis that is parallel to but offset from the first lateral axis. The generally cylindrical portion may have an end flange extending radially outward from the offset longitudinal axis. Additionally, first and second sealing rings each encircling the sidewall of the first lateral tube may be located on opposing sides of the opening so one sealing ring is closer to the first axial tube than the other sealing ring.

Advantageously the tubular fitting intersects the first lateral tube, with the first lateral tube forming a closed bottom of the tubular fitting. Alternatively, the tubular fitting may intersect a top portion of the water filter cap with the tubular fitting not being in fluid communication with the first axial flow passage. Still further, the tubular fitting may be in fluid communication with the first axial flow passage.

There is also provided a water filter cartridge assembly that includes a tubular water filter cartridge having opposed first and second ends with a filter media between the first and second ends. The filter cartridge assembly may include a first connector head as described above and in this disclosure herein, including all the variations described above and in this disclosure. The first connector head is releasably connected to the first end of the water filter cartridge by any known mechanism, including rotational mechanisms including bayonet tabs and screw threads but also including axial engagement mechanisms such as snap locks, detent mechanisms, spring biased latches, clamps and preferably V-clamps.

The water filter cartridge assembly optionally include a second connector head as described above and in this disclosure herein, including all the variations described above and in this disclosure. The second connector head may be releasably connected to the second end of the water filter cartridge by any known mechanism, including rotational mechanisms including bayonet tabs and screw threads but also including axial engagement mechanisms such as snap locks, detent mechanisms, spring biased latches, clamps and preferably V-clamps.

The water filter cartridge may advantageously an outwardly extending flange encircling the open end of the water filter cap, where the flange has at least one of two opposing sides inclined toward the other side in a direction away from the longitudinal axis, with the flange being used for a clamp mechanism. The water filter cartridge may also advantageously have the proximal end of at least one of the first and second lateral tubes be closed and have at least one cylindrical recess in that closed end extending along a recess axis which is offset from a longitudinal axis of the at least one of the first and second lateral tubes having the at least one cylindrical recess.

The water filter cartridge may include any of the connector heads described herein that is releasably connected to one of the first or second ends of the water filter cartridge by a clamp engaging an outward flange on the connector head and a contacting lip or flange on the filter housing to clamp the parts together, with the tubular fitting is in fluid communication with the first axial flow passage. The filter cartridge may also include a flush tank mounted to the tubular fitting with a flush tank valve interposed between the flush tank and the first axial flow passage, where the tubular fitting is in fluid communication with the axial tube or another fluid flow path through the connector head and in further fluid communication with the filter.

### BRIEF DESCRIPTION OF THE DRAWINGS

These and other advantages and features of the invention will be better appreciated in view of the following drawings and descriptions in which like numbers refer to like parts throughout, and in which:

FIG. 1 is a front perspective view of a filter connector in a manifold for connecting to water lines;

FIG. 2A is a rear perspective view of the filter connector in a manifold of FIG. 1;

FIG. 2B is an exploded perspective view of the filter connector and manifold;

FIG. 3A is sectional view of the filter connector and manifold, taken along section 3-3 of FIG. 2;

FIG. 3B is perspective sectional view of the filter connector and manifold of FIG. 3A;

FIG. 4 is a side view of the filter connector of FIG. 1, removed from the manifold;

FIG. 5 is a perspective view of a portion of a fluid connector for mating with the manifold;

FIG. 6 is a front perspective view of a portion of the filter connector of FIG. 1;

FIG. 7 is a side view of the portion of the filter connector of FIG. 6;

FIG. 8 is a sectional view through the middle of the portion of the filter connector of FIGS. 6 and 7;

FIG. 9A is a front, left side perspective view of two filters connected to a water line using the filter connector and manifold of FIG. 1;

FIG. 9B is a front, right side perspective view of FIG. 9A;

FIG. 10A is a front elevation view of the two filters of FIG. 9A;

FIG. 10B is a right, side view of FIG. 10A;

FIG. 10C is a left, side view of FIG. 10A;

FIG. 11 is a top elevation view of FIG. 10A;

FIG. 12 is a sectional view taken along section 12-12 of FIG. 11; and

FIG. 13 is a sectional view taken along section 13-13 of FIG. 11.

### DETAILED DESCRIPTION

As used herein, the relative terms and directions up and down, upwards and downwards, above and below, top and bottom, are with respect to the vertical axis when a person is standing on the ground and based on the assumption that the filter cartridges have a longitudinal axis on the vertical axis. The relative terms and directions inward and outward, inner and outer, are with respect to the surface on which the manifold is mounted during use measured along an axis orthogonal to that surface through the manifold and along a flow passage of the connector head, with inner being toward the support surface and outer being the opposite direction, away from the support surface along the defined axis. The relative terms and directions proximal and distal are with respect to the relative distance from the manifold support surface on which the manifold is mounted during use measured along an axis orthogonal to that surface through the manifold and along a flow passage of the connector head. Thus, for example, the end of the connector head mating with the manifold is a proximal end of that connector head.

As used herein, the following part numbers refer to the following parts: 20—manifold; 20′—second manifold; 21—support; 22—inlet port; 24—outlet port; 26—openings in manifold; 27—clip on manifold; 28—mounting flange; 30—longitudinal axis of port 22; 31—longitudinal axis of port 24; 32—connector head; 33—inlet connector tube; 34—first filter cartridge; 35—outlet connector tube; 36—top cap; 38—top clamp; 40—bottom clamp; 42—bottom connector head; 46—bottom cap; 48—lower fitting; 50—pressure gauge; 52—filter element; 54—tubular coupling; 56—ring seals; 60—flush tank; 62—neck; 64—top fitting; 66—threads; 70—second filter cartridge; 72—alternative manifold; 74—top cap on cartridge 70; 76—bayonet; 78—mating surface; 80—purge valve; 82—handle; 84—interconnecting tubing; 90—sidewall; 94—top end; 95—longitudinal axis of sidewall; 96—flange; 98a,b—sides of flange 96; 100—recess; 102—first lateral passage; 103—longitudinal axis of passage 102; 104—outlet tube; 105—outlet passage; 106—sealing area; 108—second lateral passage; 109—longitudinal axis of passage 108; 110—tube containing passage 102; 112—tube containing passage 108; 113—groove; 120—outer end portion; 122—inner end portion; 123—offset axis; 124—ridge; 126—groove; 128—outlet tube on manifold; 129—inlet tube on manifold; 130—sidewall; 132—flat on sidewall; 134—opening in sidewall; 136—strut; 138—bottom; 140—groove; 142—locking groove; 141—alignment flange; 143—alignment recess; 144—end flange;

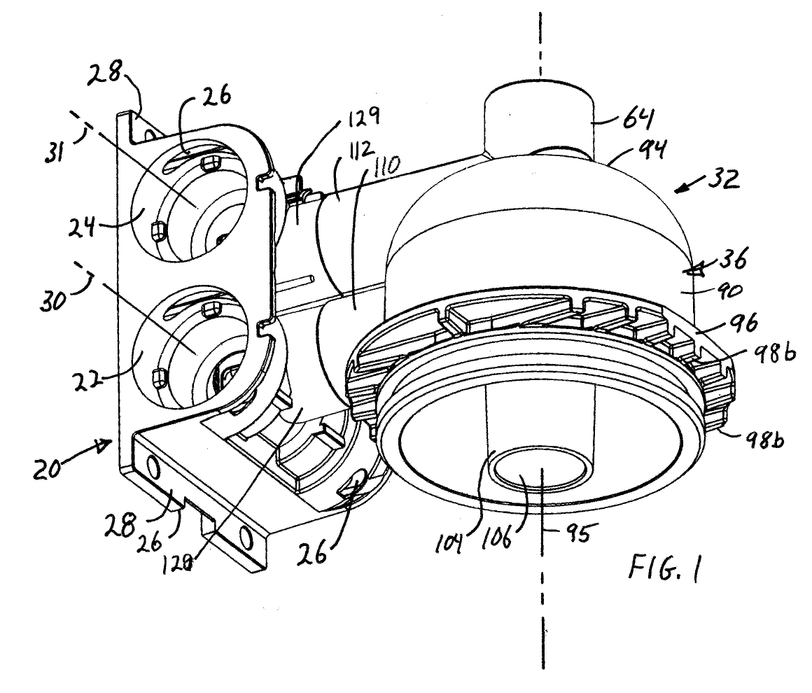

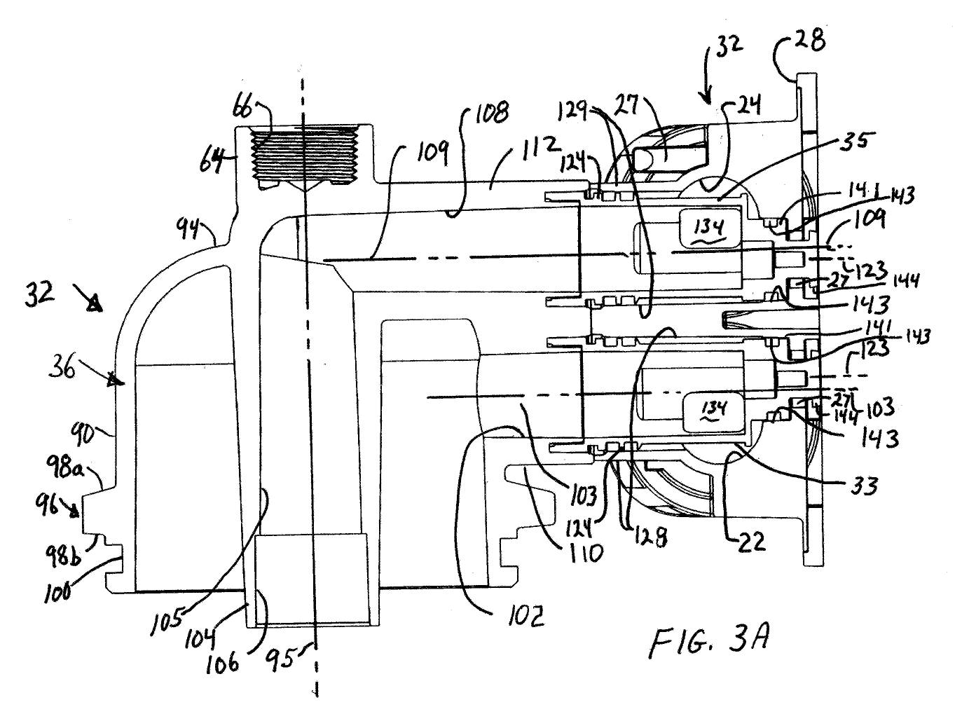

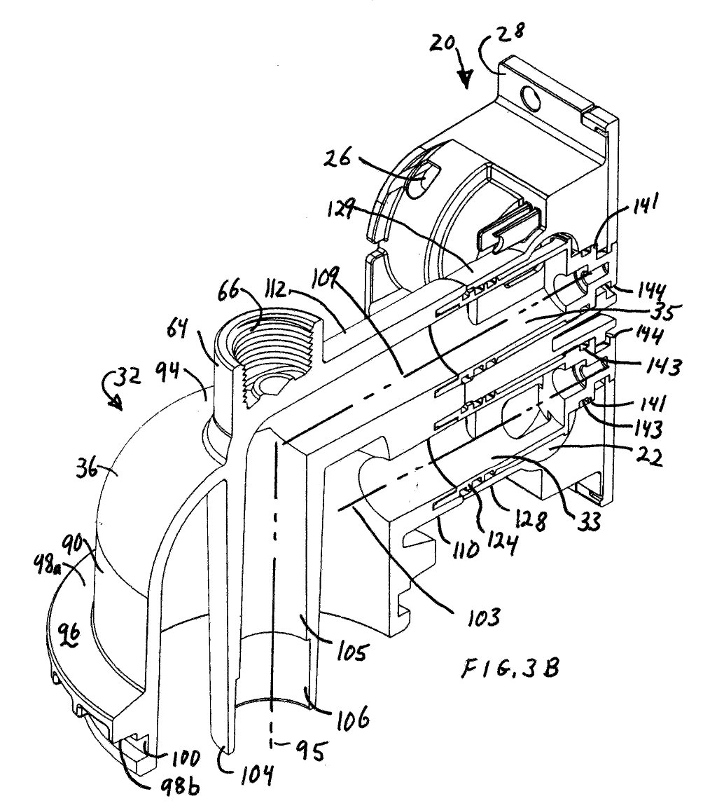

Referring to FIGS. 1-2 and 9-12, a manifold 20. The manifold 20 has water inlet and outlet ports 22, 24 which are the openings for fluid passages extending through the manifold along axes 30 and 31, respectively. The axes 30, 31 are shown as straight but need not be so. The ports 22, 24 receive fluid conduits (e.g., as water lines) in a fluid tight connection during use to place the manifold 32 in fluid communication with a source of water (e.g., unfiltered water) and to carry filtered water away from the manifold. Depending on the filter cartridge configuration and use, the ports 22, 24 may be either an inlet port or an outlet port. For ease of description port and fluid passage 22 is treated as an inlet port and the port and fluid passage 24 is treated as an outlet port. The fluid conduits are typically tubular pipes, commonly of plastic or metal tubing, with mating end fittings on the ends of the conduits received in the manifold's ports. Clips 27 (FIG. 3) may pass through openings 26 in the manifold 20 and mating slots or grooves in the outer wall of the conduit end fittings hold the fittings in the manifold 20 during use. O-ring seals on the outside of the end fittings may provide a fluid tight connection when the ports 22, 24 are cylindrical recesses. Other cross-sectional shapes of end fittings, ports and ring seals may be used.

The manifold 20 may have mounting flanges 28 extending along one or more sides of the manifold, preferably parallel to the longitudinal axis 30, 31 of the ports 22, 24, with fastener openings for threaded or non-threaded fasteners to connect the manifold to the support during use. The axes 30, 31 are preferably generally horizontal or generally vertical during use but need not be so.

A filter connector or connector head 32 has inlet and outlet connector tubes 33, 35, respectfully, extending laterally away from the manifold 20 and support 21 and a cap 36 with an opening oriented downward to connect to a top of a first filter cartridge 34 to place the first filter cartridge 34 in fluid communication with the manifold 20. The filter connector head 32 is described in more detail later. The first filter cartridge 34 may be a UF filter or a RO filter or other suitable type of filter. The first filter cartridge 34 is cylindrical and advantageously releasably connected to the connector head 32 and its top cap 36 by a clamp 38, such as a V-clamp.

The first filter cartridge 34 may be supported solely by the filter connector head 32 and top cap 36 from which the first filter cartridge 34 is suspended. Advantageously though, the bottom of the first filter cartridge 34 is connected by a second, bottom clamp 40 to a second, bottom connector head 42 having a second, bottom cap 46. Bottom cap 46 is in fluid communication through bottom connector tubes 33, 35 with bottom manifold 20 that is connected in turn to the support 21.

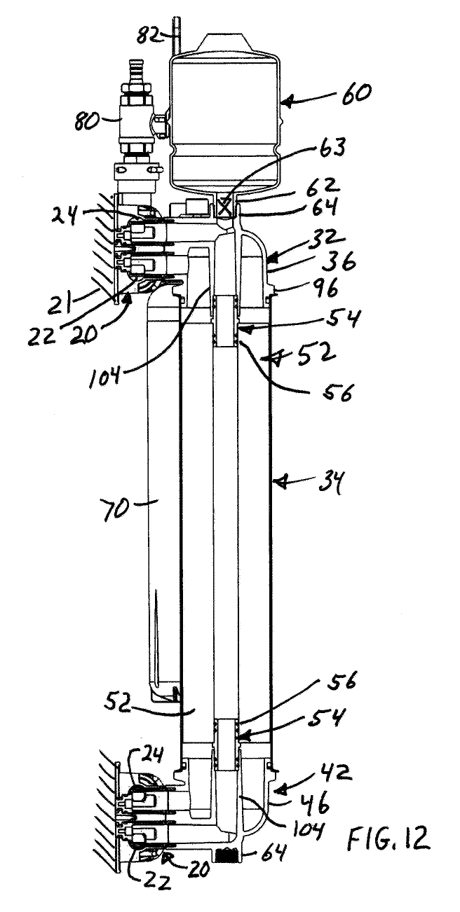

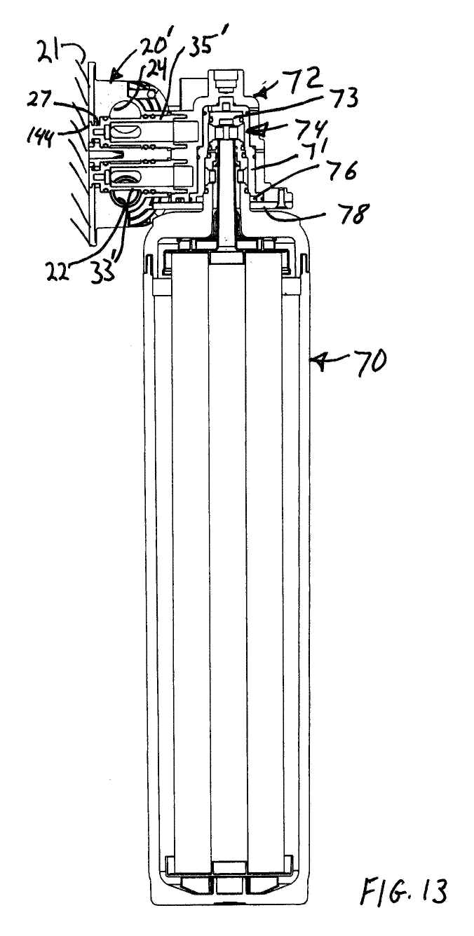

The top and bottom connector heads provide support for the first filter cartridge 34 at opposing ends of the filter cartridge. That double ended support reduces the weight supported by a single, suspended configuration. The use of two removable clamps 38, 40 allows the filter element 52 (FIG. 12) between the caps 36, 46 to be easily replaced by removing the connector tubes 33, 35 from the manifold 20, laterally to separate the top and bottom connector heads 32, 42 from their respective manifolds and supports. The top and bottom clamps 38, 40 may then be removed and the heads 32, 42 and their respective caps 36, 46 may be axially separated from the intervening filter element 52 and its enclosing housing. As seen in FIG. 12, upper and lower tubular couplings 54 with ring seals 56, such as O-rings, may connect the central flow passages in the heads and caps which are described in more detail later. Once a new filter 52 is obtained, the upper and lower tubular couplings 54 are sealed to the respective flow passages in the mating top and bottom caps 36, 46. The top and bottom caps 36, 46 and the connector tubes 33, 35 of each of the respective top and bottom connector heads 32, 42 are then engaged laterally with the upper and lower manifolds 20.

Note that the filter cartridge 34 in the depicted embodiment comprises a cylindrical housing with a tubular cylinder, with the housing open at both opposing ends, and with those opposing ends configured to connect to connector heads 32, 42 and their respective caps 36, 46. If the filter cartridge 34 had one end closed, then it would be cantilever mounted, preferably suspended from the top cap 36 and top connector head 32.

The use of a bottom and top manifold 20 and top and bottom connector heads 32, 42 also allows more flexibility on fluid connections to various appliances and allows increases volume of water input and filtered water output. The lower manifold 20 advantageously has a drain fitting 48 in fluid communication with the lower outlet port and outlet flow passage 24. A drain valve 49 is placed between the drain fitting and the lower manifold 20, with the valve being normally in a closed position to block flow. That lower fitting 48 may optionally be used to drain rejected water for RO systems or other suitable fittings. There is thus provided a method and apparatus for supporting opposing ends of a filter cartridge, thus reducing the weight carried by each end support.

Moreover, while FIGS. 9-12 show the first filter cartridge 34 in a vertical orientation, that filter cartridge could be horizontal with the manifolds 20 on the same generally horizontal axis and in a corresponding orientation as though the figures were rotated 90°. Alternatively, the filter cartridge could be inclined at any desired angle, with the mating manifolds, caps, heads and water conduits arranged for suitable use of the filter cartridge.

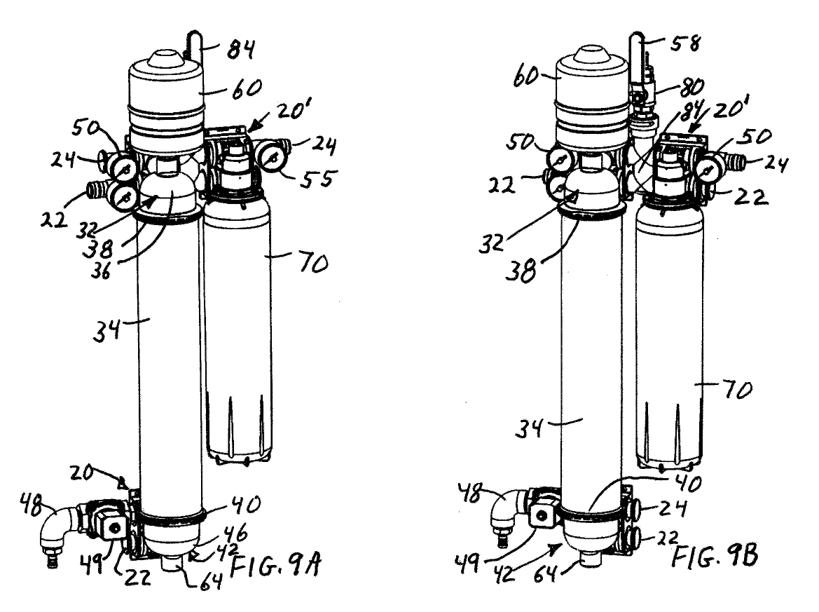

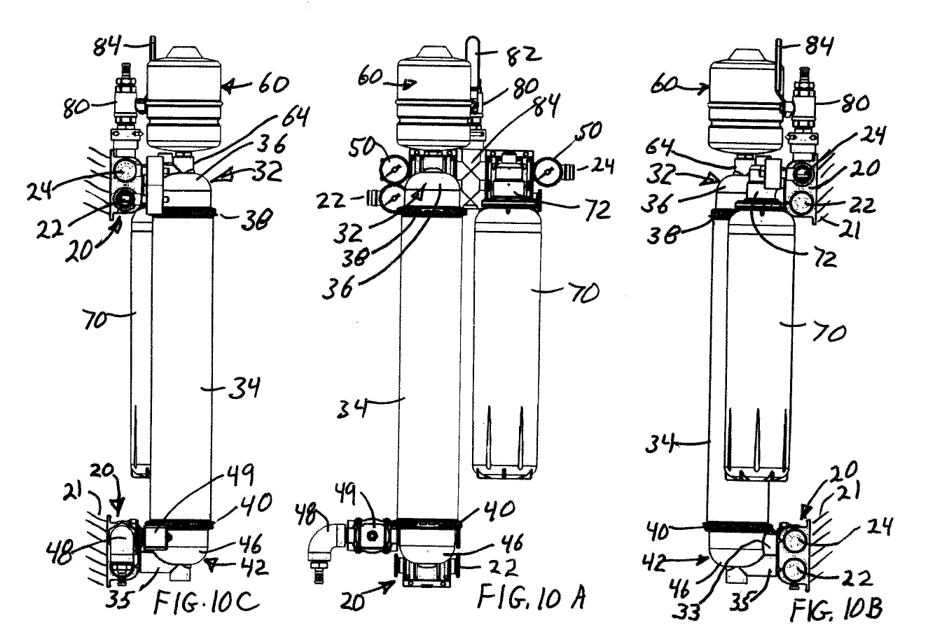

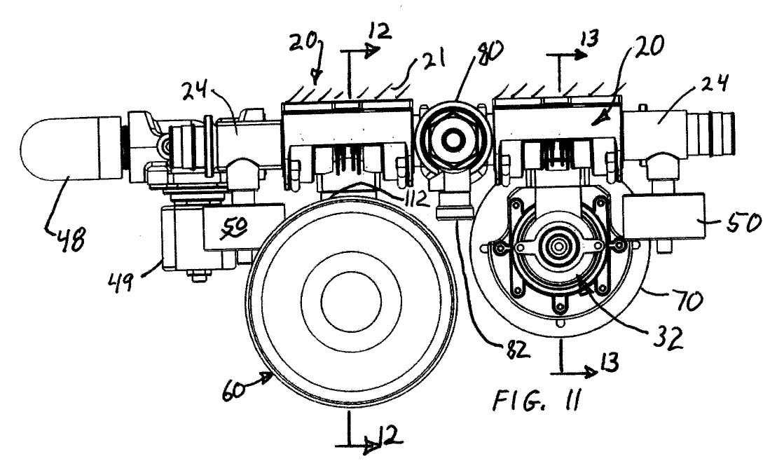

The bottom manifold 20 in FIG. 10C shows an elbow joint 48 in fluid communication with one of the inlet and outlet 22, 24. As desired, to monitor pressure, pressure gages 50 may optionally be placed in fluid communication with any of the inlet or outlet passages 22, 24, 34, 35 which are in fluid communication with the manifold.

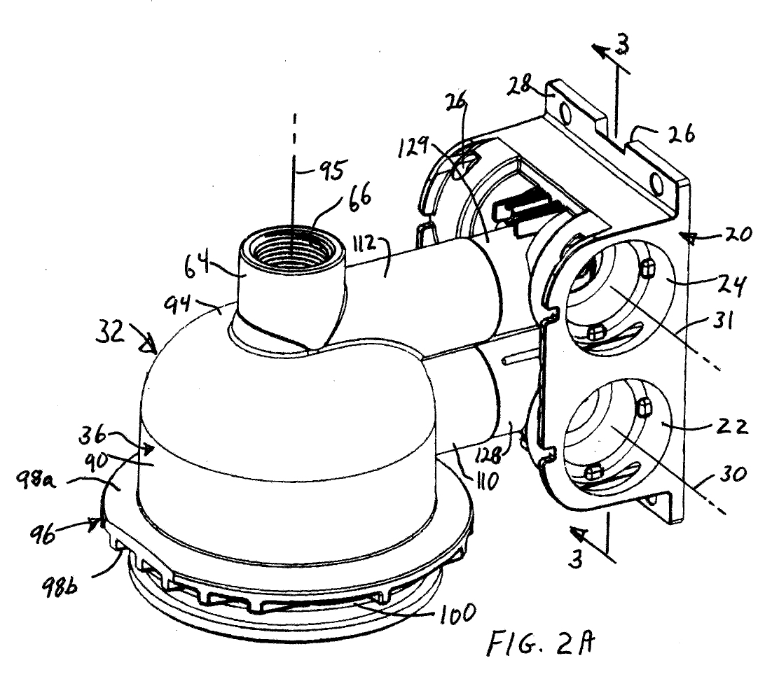

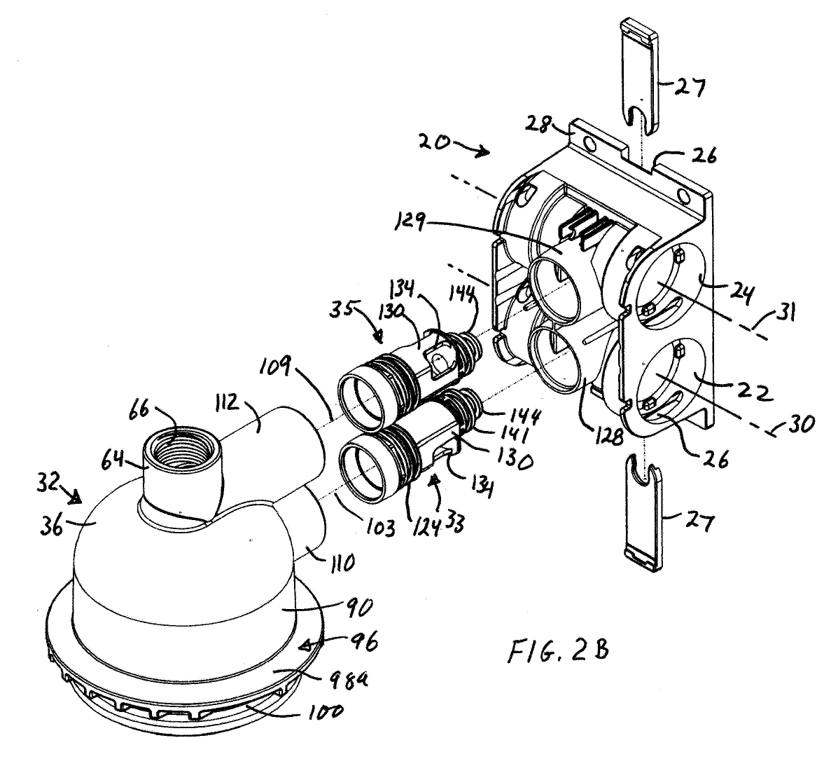

A flush tank 60 having a tubular neck 62 on the bottom end of the flush tank is placed in fluid communication with a top fitting 64 on the top of the upper cap 36 and top connector head 32. A flush valve 63 is located in the neck 62, tank 60 or connector head to control flow into and out of the tank, with the valve typically located in the neck 62 or the tank. Advantageously the top fitting 64 is tubular with a threaded interior surface 66 (FIG. 2) while the neck 62 has mating external threads so the flush tank may be threadingly engaged with the top fitting 64 on the top connector head 32. The flush tank is in fluid communication with what is normally the outlet connector tube 35 and outlet tube 104 to allow flushing of the first filter cartridge 34 as described later. Advantageously, the threaded connection between the flush tank 60 and top connector head 32 is fluid tight so no water leaks out during use or flushing.

Referring to FIGS. 1, 9-11 and 13, a second, top manifold 20 may be placed in fluid communication with the previously described top manifold 20 to which the first filter cartridge 32 is connected. Further, conventional filters and manifolds may be placed in fluid communication with the manifold 20. In these figures, a second filter 70 is provided and preferably comprises a cantilever mounted, pre-filter 70, used to pre-filter the water provided to manifold 20 and filter cartridge 34, using a second, wall mounted manifold 20'. The inlet ports 22 and outlet ports 24 of the first and second top manifolds 20 and 20′ are in fluid communication, advantageously by tubes extending between the manifolds and any intervening fittings. The second top manifold 20′ is placed in fluid communication with a filter manifold 72 by modified connector tubes 33′ and 35′, which have inner ends coaxially aligned with the connector tubes 33′ and 35′ and an end flange 144 and recess 142 to receive a retaining clip 27 (FIG. 3) passed through openings in the housing to interlock the end flange and manifold 20 and restrain withdrawal of the end flange 144 and top connector head 32 from the manifold. The filter cartridge has its own manifold 72 containing a barrel valve 71 and filter cap 73 as described in U.S. patent application Ser. No. 14/693,631 filed Apr. 22, 2015, publication No. 2015-0307365, the complete contents of which are incorporated herein by reference. This alternative filter manifold 72 allows the vertical insertion of the second filter cartridge 70 having a filter cap 74 with coaxial inlet and outlet nozzles separated by two ring seals of different diameter, with a further ring seal at a top end of the filter cap, and yet another ring seal adjacent the bottom or base of filter cap. Bayonet mounts 76 engage mating surfaces 78 in the alternative filter manifold 72 so the second filter cartridge 70 is suspended axially from the alternative filter manifold. The connecting tubes in this embodiment have all portions extending along the same longitudinal axis.

Referring to FIGS. 9-12, between the first and second top manifolds 20, 20′ is a purge valve 80 operated by rotating handle 82. The purge valve 80 is in fluid communication with the interconnecting tubing 84 (FIGS. 9B and 10A) extending between the inlets 22 and outlets 24 of the first and second top manifolds 20, 20′. The purge valve 80 allows air in the interconnecting tubing 84 and top manifolds 82 to be vented when the handle is rotated to rotate a ball internal to the valve 80 which rotation aligns a passage in the ball with an externally opening passage to vent air from the valve 82, tubing 84 and manifolds 82. Such vent valves are known in the art and not described in detail herein.

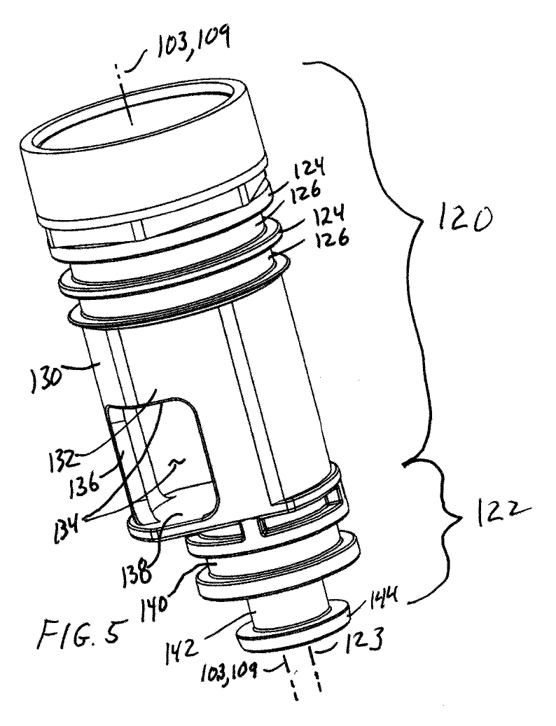

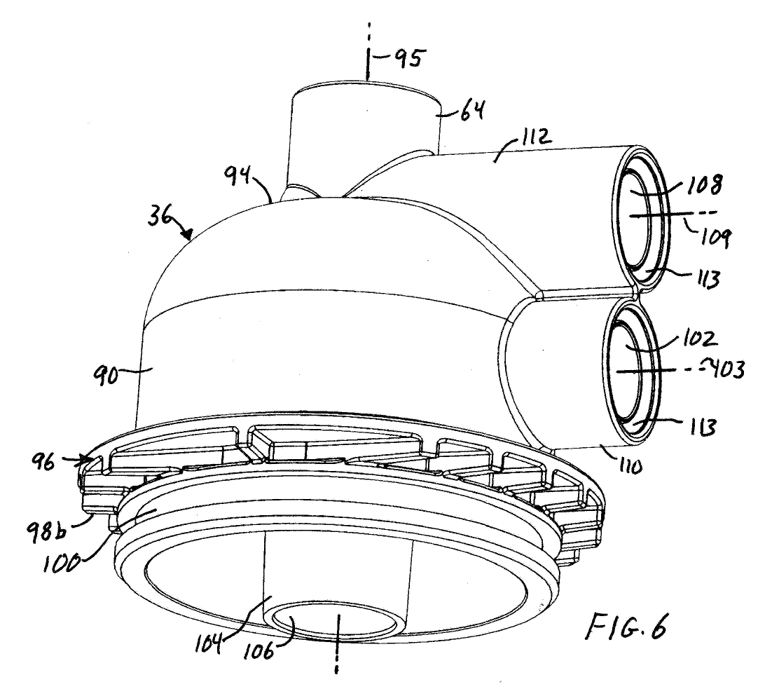

Referring to FIGS. 1-8, a more detailed description of the connector heads 32, 42 is provided. As the top and bottom connector heads 32, 42 are the same except for orientating them to face each other, only the top connector head 32 is described here. Viewed from the outside, the top cap 36 has a generally cylindrical side wall 90 with longitudinal axis 95. The top cap 36 has a top end 92, preferably domed upward, from which extends the top fitting 64. An outwardly extending flange 96 encircles the lower periphery of the top cap 36. The flange 96 advantageously has opposing top and bottom sides 98a, 98b with at least one wall inclined toward the other in a direction away from the longitudinal axis 95 and the axial tube 104. Advantageously, the lower flange 98b is less inclined and more radial oriented than the upper flange 98a. As seen in FIGS. 1-4 and 6-7, the flange 96 may not have a uniform cross-section.

The bottom facing side 98b of the flange 96 is shown with a ribbed construction in which side 98b is formed from the bottom facing or downward facing sides of the ribs. The ribbed construction is believed to improve molding tolerances, and the downward facing ribs are advantageously tapered to form a slightly inclined surface tapered in a direction opposite that of the top surface 98a. The flange 96 has a smaller axial length at its outward end and a longer axial length at its inner end adjacent sidewall 90, measured along axis 95. Thus, the flange 96 is thinner at its outward periphery and the faces 98a, 98b are advantageously inclined to achieve that shape. A recess or gland 100 encircles the outer periphery between the flange 96 and the bottom of the sidewall 90. During use, a ring seal, preferably an O-ring seal, is placed in the gland 100.

The sidewall 90 of the top cap 36 encloses a volume and defines an inlet passage. In use, the sidewall 90 and top cap 36 cover a top (or other portion) of a filter to form a fluid path. Extending laterally from and extending through one side of the sidewall 90 and opening onto is a first lateral passage 102 which extends along longitudinal axis 103. Axis 103 advantageously intersects axis 95, but may be offset therefrom. First lateral passage 102 is preferably cylindrical, with a generally circular cross section and extends through the sidewall 90 to place first lateral passage 102 in fluid communication with the inside of the top cap 36 and sidewall 90. The first lateral passage 102 is coaxial with and joins the inlet connector tube 33. Advantageously, the sidewall 20, first lateral fluid passage 102 and inlet connector tube 33 form a first fluid passage and advantageously form an inlet passage in fluid communication with inlet 22 port of the manifold 20.

The top connector head has an outlet tube 104 with an internal outlet passage 105, with both the tube 104 and passage 105 being coaxial with longitudinal axis 95 and inside the sidewall 90. The outlet tube 104 extends through the inside to top cap 36 and thus the inlet portion of the passage formed by the top cap 36 and its sidewall 90 is annular shaped. The bottom, or free end of the outlet tube 104 advantageously but optionally has a cylindrical sealing area 106. Extending laterally from the top end of the outlet tube 104 and outlet passage 105 is a second lateral passage 108 that is advantageously coaxial with outlet connector tube 35 and extends along longitudinal axis 109. The axis 109 advantageously intersects axis 95 but may be offset therefrom. Axes 108, 103 may be in the same general vertical plane, or offset from each other. The top end of the outlet tube 104 and its outlet passage 105 advantageously is blocked by a wall of the top end 94 of the cap, or by the tubular wall 112 forming second lateral passage 108, or both. Opposite the top end of the outlet tube 104 and its outlet passage 105 is the threaded recess 66 of the top fitting 64. The top fitting 64 is advantageously coaxial with axis 95. The bottom of the top fitting 64 is preferably blocked, at least initially, from fluid communication with fluid passages 105, 109. The intervening portion of the cap 36 and/or first second tube 112 which are intersected by the tubular fitting 64 block the bottom of the tube, making it a close ended fitting or a blind hole. As desired, a user may optionally drill out the bottom of the tubular top fitting 64 to form a fluid passage in communication with outlet tube 104, second lateral passage 108 and the manifold outlet port 35. Forming such a fluid passage through the tubular top fitting 64 allows use of the flush tank 60 as shown in FIGS. 9-12, or allows other devices to be placed in fluid communication with the outlet tube 104 and its associated fluid passage. Alternatively, the tubular fitting 64 may be made with a through passage placing it in fluid communication with the outlet tube 104, abut a cap or plug may be used to releasably block the tubular top fitting 64. The cap or plug may have threads to mate with internal threads 66, or external threads may be provided on the tubular top fitting 64.

Referring to FIGS. 3-6, the first and second lateral passages 102, 108 are preferably formed in generally cylindrical tubes 110, 112 respectively, that are coaxial with axes 103, 108, respectively. The tubular top fitting 64 may intersect the second lateral passage 112, may intersect the (preferably) domed top end 94 of the cap or the cap sidewall 90, or any combination of the above.

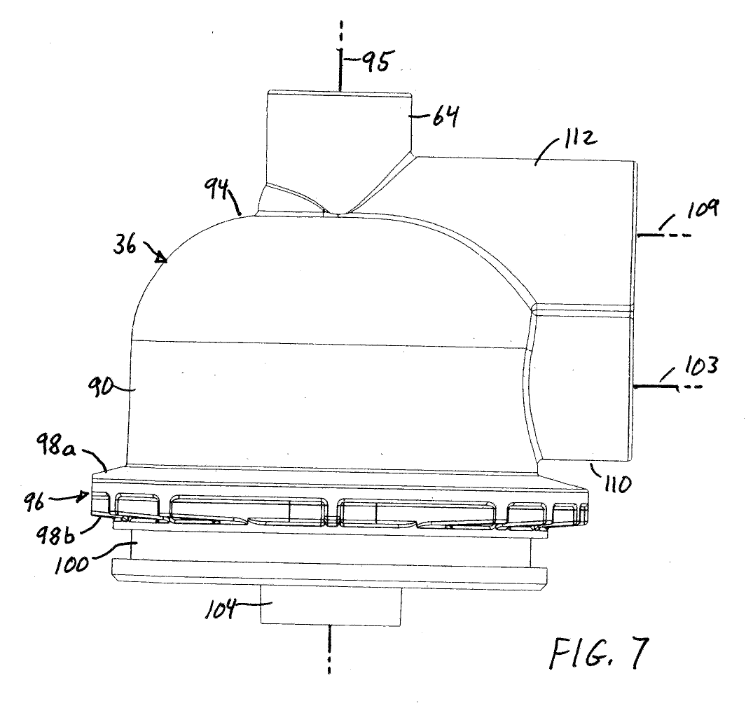

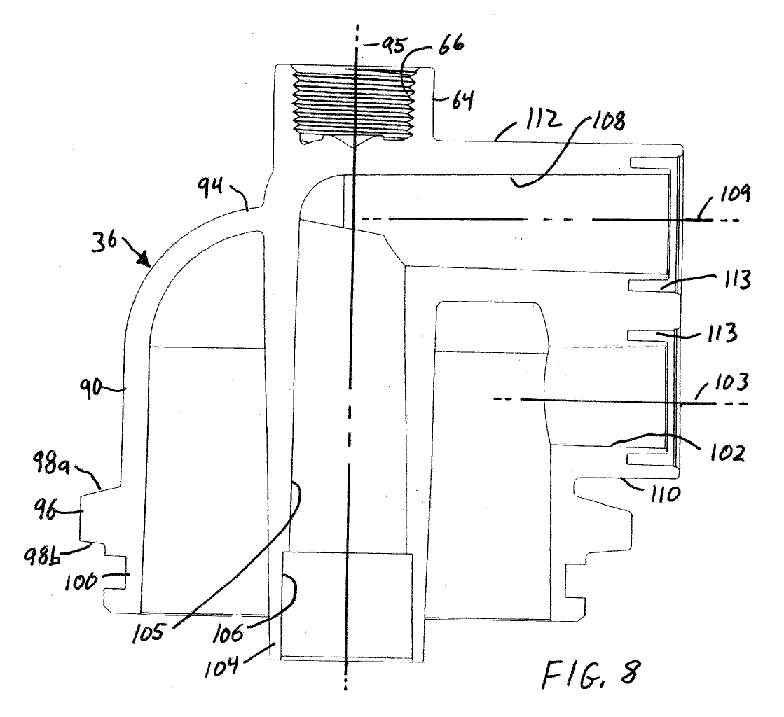

The inward facing ends of tubes 110, 112 containing the first and second lateral fluid passages 102, 108, respectively, preferably each have an annular groove 113 (FIG. 8) into which the outward facing ends of the connector tubes 33, 35 fit. Advantageously, the connector tubes 33, 35 are spin welded to the mating ends of the tubes 110, 112. Other permanent connecting mechanisms may be used, including adhesives or force fits. Other releasable connections may be used, including threads or snap fits. Advantageously, the top connector head 32 includes the top cap 36, top fitting 64, tubes 110, 112 and connectors 33, 35. Those parts may be integrally molded in one pour or single injection to form the integral top connector head 32. But spin welding connector tubes 33, 35 to the top cap 36 is believed preferable.

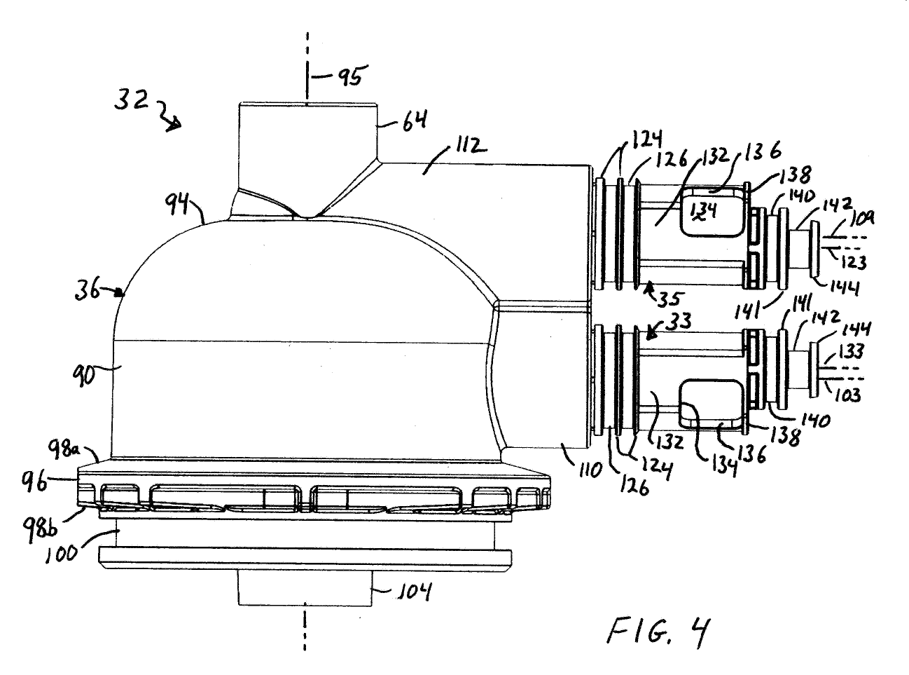

Referring to FIGS. 2-5, the connector tubes 33, 35 are described in more detail. Each connector tube 33, 35 is advantageously substantially the same, so only connector tube 33 is described in detail as though it were in its use position providing fluid communication between the manifold 20 and the connecting head 32. The connector tubes are configured to have a free end that releasably mates with the manifold 20 to provide a fluid tight connection and allows water to pass from the top connector head 32 to the manifold. Thus, the inner end of the connector tube 33 has a lateral opening so water flows along axis 103, 109 and then laterally to those axes through one of the inlet or outlet fluid passages 22, 24 of the manifold. One configuration believed suitable for providing the fluid connection is shown in FIG. 5 and has an outer end portion 120 offset from inner end portion 122 and extending along offset axis 123. The inner end portion 122 is proximal to the manifold and thus is also the proximal end portion 122 relative to the distal end portion 120 which is further from the manifold 20 and the support surface 21 to which the manifold is mounted during use.

The outer end portion 120 is preferably, but optionally, configured to spin weld with one of tubes 110, 112. Advantageously, one or more circumferential ridges 124 separated by grooves 126 are adjacent the outer end that is spin welded to one of the tubes 110, 112. Advantageously there are fewer than 10, preferably less than five, and more preferably two or three ridges 124. Ring seals may optionally be placed in one or more of the circumferential groves to provide a fluid tight seal with the inside of the mating inlet tube 128 and outlet tube 129 (FIG. 3) on the manifold 32 into which the connecting tube 33 and 35, respectively, fit and seals during use. The ridges 124 also provide rigidity or stiffness to the inner end of the connecting tubes to align the connecting tubes with the mating tubes 128 of the manifold 32

The connecting tubes 33, 35 have a sidewall 130 which may be circular in cross-section and smaller in diameter than the ridges 124. But advantageously sidewall 130 has two opposing flats on opposite sides so the cross-section has rounded ends conforming to the diameter of grooves 126, joined by two opposing flat and parallel surfaces forming chords of the circular diameter. Each sidewall 132 advantageously has an opening 134 which may optionally extend into one of the curved portions of the sidewall 130, advantageously into the lower portion of each sidewall, but with the openings 134 separated by a strut 136 advantageously formed from a portion of the sidewall 132 and advantageously taking the form of a curved strut or curved end-wall having the outer curvature of the curved body portion of the tubular connectors 33, 35. The two openings 134 are opposite each other and form a fluid passage through the sidewall 130.

The sidewall 130 joins a bottom 138 generally orthogonal to the axes 103, 109. The bottom 138 advantageously conforms to the shape of the sidewall 130, so it has curved ends joined by opposing flat sides that are generally parallel. As seen in FIG. 3, the inner end portion 122 is stepped inward and extends along offset axis 123. The closed end of the connector tubes 33, 35 has an internal stepped cavity of reducing diameter that conforms to the outer profile which also has a stepped profile of reducing diameter. The internal stepped cavities are generally cylindrical and extend along a recess axis which coincides with axis 123. The internal cavity or cavities allow a generally uniform wall thickness (except for flanges described later) to make it easier to mold the parts.

Connected to and preferably extending from the bottom 130 in a direction toward the support 21 is the outer end portion 122 which forms an alignment and sealing structure. The outer end portion 122 has a cylindrical shape an annular groove or gland 140 for containing a sealing ring (not shown), preferably an O-ring, although other cross-sectional shapes may be used for the sealing rings. During use, the sealing ring in groove 140 abuts the mating surface of a mating cylindrical recess such as alignment recess 143 (FIG. 3) to seal against that mating surface. The recess 143 may have other cross-sectional shapes. The optional seals in groves 126 (FIG. 5) and the fluid tight connection (e.g., via spin welding) of the connector tubes 33, 35 to the tubes 110, 112 provide a fluid tight connection on an outer side of the inlet and outlet flow passages 22, 22 through the manifold, and the seal in grove 140 provides a fluid tight connection with the manifold on the inner side of flow passages 22, 24, with water passing along the length of flow passages 22, 24 passing through the openings 134, and along one of the axes 103, 109. The cylindrical shoulder and alignment flange 141 on opposing sides of the groove 140 abut the sidewall of a cylindrical recess 143 in the manifold to guide the connecting tubes 33, 35 into position in a specific orientation and also restrict lateral motion relative to axes 103, 109 and 123.

The inner end of the inner end portion 122 has a smaller stepped diameter groove 142 located between the alignment flange 141 and end flange 144. During use, the alignment flange 141 enters an alignment recess 143 (FIG. 3) in the manifold 32 that is on the inward side of the fluid flow passages 22, 24, to help align the connecting tubes 33, 35. The alignment recess 143 is advantageously a cylindrical surface on the inner portion of the manifold that opens into the mating inlet and outlet tubes 128, 129, but extends along an axis 123 that is offset from the axis 103, 109 of the respective tubes 128, 129. Thus, the alignment recesses extend along parallel axes 123 which are preferably parallel to but offset from the axes 103, 109 along which the mating tubes 128, 129 extend during use, and along which connector tubes 33, 35 extend during use. The retaining flange 144 interlocks with a clip 27 (FIG. 3) inserted through an opening in the housing of the manifold 20 so prevent removal of the flange 144 and thus the top connector head 32 from the manifold.

In use, the connector head 32 is connected to a filter cartridge such as filter cartridges 34. The top cap 36 is placed over the open top of the filter cartridge 34 and that requires the top cap 36 and filter 34 have mating configurations that place the inlet and outlet flow passages in fluid communication. Thus, placing the top cap 36 on the filter cartridge 34 engages the periphery of the cap 36 with the top of the filter cartridge to align the fluid inlet passage, and places the fluid outlet tube 104 in sealing fluid communication with the outlet of the filter cartridge 34. The cap 36 is then connected to the filter cartridge 34.

The connection of the cap 36 and cartridge is advantageously achieved various ways, with clamped connection (e.g., V-clamp 38, 40) being illustrated. Threaded connections or bayonet connections may be used as may other connections, but the clamped connection is believed suitable for heavier filters. The following description assumes the orientation shown in the figures with a downward facing connector head 32, but the orientation may vary. The top of the filter cartridge 34 has a lip that abuts the bottom facing surface 98b of the flange 96 on the top connector head 32. A clamp is placed over the filter cartridge's lip and flange 96 and those parts are clamped together. As the downward facing side 98b is inclined, the lip on the filter cartridge may be deformed slightly. The filter cartridge 34 is advantageously is coaxial with axis 95 of the top connector head 32. The gland 100 and its O-ring seal advantageously seal against the inside surface of the filter cartridge. The filter cartridge 34 and the connector head 32 have the inlet and outlet connector tubes 33, 35 extending laterally to the longitudinal axis of the filter 95, in a plane orthogonal to the axis 95.

The connector tubes 33, 35 are inserted laterally into the mating tubes 128, 129 of the manifold 32 as shown in FIG. 3, with the inner end portion 122 (FIG. 5) of the connector tubes each entering a separate alignment recess 143 extending along axis 123 that is offset from the axis 103, 109 of the respective connector tube 33, 35 associated with the respective end portion 122. The connector tubes 33, 35 are inserted into mating tubes 128, 129 until a removable locking clip 27 can be inserted through a hole in the housing to engage the locking groove 142 and interlock the inner end portion 122 and top connector head 32 to the manifold 20. Because the end portions 122 are offset relative to the connector tubes 33, 35, the top connector head 32 may be inserted only in one orientation, the orientation that aligns the end portions 122 with the alignment recess 143. Because there are two connecting tubes 33, 35 and two mating recesses 128, 129 to receive those connecting tubes, the top connector head 32 may be inserted in either of two orientations, 180° apart from each other, with the cap head 32 facing upward or downward in the embodiment used for illustration. But while the mating tubes 128, 129 of the manifold 32 may receive the connecting tubes 33, 35 in two different orientations, the alignment recesses 143 require only one orientation to mate with both the connecting tubes 33, 35 and the alignment recesses 143. A similar alignment may be achieved by using different sized connecting tubes 33, 35 or protrusions on one mating part and recesses the other mating part. While it is preferable to offset axis 123 from the axis 103, 109 of the associated lateral tube 110, 112, the offset is optional. Similar connector tubes are shown in FIG. 13 with no offset.

Fluid, such as water, enters the inlet port and inlet passage 22 of the manifold, passes through the manifold to enter opening 134 of inlet connecting tube 33, passes through first lateral passage 102 and the top cap 36 with its sidewall 90, and into the filter 34. After being filtered, the water passes from the filter through outlet 104 on the top cap 36, through the second lateral passage 108 and its connecting tube 35 and its opening 134 into the outlet flow passage and outlet port 24 of the manifold 32.

The wall between top fitting 64 and fluid passages 105, 109 may be removed and various devices placed in fluid communication with passages 105, 109, such as flush tank 60. The flush tank 60 may be filled with water passing through the outlet tube 104 by opening flush valve 63 until the tank is filled to a desired level at which point the flush valve 63 is closed to retain water in the flush tank. The flush tank 60 typically has a flexible, resilient bladder in it so the water in the flush tank is pressurized by the resilient bladder buy by its height above the connector head 32. When it is desired to flush the filter, the outlet valve 49 on the bottom of the filter is opened and the flush tank the flush valve 63 is opened so that the pressurized water in the flush tank 60 is directed down the outlet tube 104, through the filter cartridge 34 and out the outlet tube and the drain fitting connected to the outlet. When flushing is completed, the bottom valve 49 is closed, the flush tank is filled again with water, and the flush valve 63 is closed. The valves 49, 63 may be manually operated or automatically operated by known mechanisms such as solenoids, electric motors, and other mechanisms.

As briefly described, removable retainer clips may pass through mating recesses in the manifold and correspondingly aligned parts of the top connector head 32 to retain the connector head in suitable connection with the manifold 32. Clips inserted orthogonal to the axes 103, 109 are believed suitable. But spring-loaded latches aligned with axes 103, 109 and engaging parts of the top connector head 32 and the manifold are also believed suitable. Other releasable connectors may be used.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The above description is given by way of example, and not limitation. Thus, while the above description is given for a water filter the method and apparatus are suitable for use with fluids other than water. Given the above disclosure, one skilled in the art would recognize that while cylindrical tubes are described herein, tubes with other cross-sectional shapes other than circular, could be used. Additionally, the fitting 64 may be made with an open bottom placing the fitting in fluid communication with the outlet tube 104. Further, the various features of this invention can be used alone, or in varying combinations with each other and are not intended to be limited to the specific combination described herein. Thus, descriptions of the top connector head and parts associated therewith may also be used for the bottom connector head and associated parts and vice versa. Thus, the invention is not to be limited by the illustrated embodiments.

What is claimed is:

1. A connector head for a water filter cartridge having a housing containing a filter material, comprising:
a water filter cap having an open end and an opposed second end joined to the open by a wall, the water filter cap having a longitudinal axis encircled by the open end of the water filter cap;
a first axial tube extending along the longitudinal axis and defining a first axial flow passage extending along a portion of the longitudinal axis of the water filter cap;
a first lateral tube extending laterally outward and intersecting the first axial tube, the first lateral tube defining a first lateral tube passage in fluid communication with the first axial flow passage, the first lateral tube having a first opening in a sidewall of the first lateral tube at or adjacent to a proximal end of the first lateral tube;
a second lateral tube extending laterally outward and intersecting at least one of the wall of the water filter cap and the second end of the cap, the second lateral tube defining a second lateral tube passage in fluid communication with an inside of the water filter cap, the second lateral tube having a second opening in a sidewall of the second lateral tube at or adjacent to a proximal end of the second lateral tube; and
a tubular fitting intersecting at least one of the water filter cap or first lateral tube and extends along the longitudinal axis.

2. The connector head of claim 1, further comprising an outwardly extending flange encircling the open end of the water filter cap, the flange having at least one of two opposing sides inclined toward the other side in a direction away from the longitudinal axis.

3. The connector head of claim 2, further comprising a sealing ring located between the flange and the open end of the water filter cap.

4. The connector head of claim 1, wherein the proximal end of at least one of the first and second lateral tubes is closed and has at least one cylindrical recess in that closed end extending along a recess axis which is offset from a longitudinal axis of the at least one of the first and second lateral tubes having the at least one cylindrical recess.

5. The connector head of claim 1, wherein the first lateral tube extends along a first lateral axis and has a generally cylindrical portion at a proximal end of the first lateral tube, the generally cylindrical portion having an offset longitudinal axis that is parallel to but offset from the first lateral axis.

6. The connector head of claim 5, wherein the generally cylindrical portion has an end flange extending radially outward from the offset longitudinal axis.

7. The connector head of claim 1, further comprising first and second sealing rings each encircling the sidewall of the first lateral tube and located on opposing sides of the opening so one sealing ring is closer to the first axial tube than the other sealing ring.

8. The connector head of claim 1, wherein the tubular fitting intersects the first lateral tube, with the first lateral tube forming a closed bottom of the tubular fitting.

9. The connector head of claim 1, wherein the tubular fitting intersects a top portion of the water filter cap, the tubular fitting not being in fluid communication with the first axial flow passage.

10. The connector head of claim 1, wherein the tubular fitting is in fluid communication with the first axial flow passage.

11. A water filter cartridge assembly, comprising:
a tubular water filter cartridge having opposed first and second ends with a filter media between the first and second ends;
a first connector head as in claim 1, releasably connected to the first end of the water filter cartridge;
a second connector head as in claim 1, releasably connected to the second end of the water filter cartridge.

12. A water filter cartridge assembly, comprising:
a tubular water filter cartridge having opposed first and second ends with a filter media between the first and second ends;
a first connector head as in claim 4, releasably connected to the first end of the water filter cartridge;
a second connector head as in claim 4, releasably connected to the second end of the water filter cartridge.

13. A water filter cartridge assembly, comprising:
a tubular water filter cartridge having opposed first and second ends with a filter media between the first and second ends;
a first connector head as in claim 3, releasably connected to the first end of the water filter cartridge by a clamp engaging the flange;
a second connector head as in claim 1, releasably connected to the second end of the water filter cartridge.

14. A water filter cartridge assembly, comprising:
a tubular water filter cartridge having opposed first and second ends with a filter media between the first and second ends;
a first connector head as in claim 1, releasably connected to the first end of the water filter cartridge by a clamp engaging the flange, and wherein the tubular fitting is in fluid communication with the first axial flow passage;
a flush tank mounted to the tubular fitting with a flush tank valve interposed between the flush tank and the first axial flow passage;
a second connector head as in claim 1, releasably connected to the second end of the water filter cartridge; and
a flush valve in fluid communication with the second fluid cartridge head.
